(19) United States
(12) Patent Application Publication
(10) Pub. No.: US 2025/0209191 A1
(43) Pub. Date: Jun. 26, 2025

(54) RULES BASED POLICY DRIVEN ENGINE AND METHODS OF USE

(71) Applicant: Sertainty Corporation, Nashville, TN (US)

(72) Inventor: Behzad Nadji, Tiburon, CA (US)

(21) Appl. No.: 18/990,490

(22) Filed: Dec. 20, 2024

Related U.S. Application Data
(60) Provisional application No. 63/612,476, filed on Dec. 20, 2023.

(51) Int. Cl. G06F 21/62; G06F 21/31

(52) U.S. Cl. CPC G06F 21/6209; G06F 21/31

(57) ABSTRACT

In an aspect, an apparatus is presented. An apparatus may include a processor and a memory communicatively coupled to the processor. A memory may contain instructions to cause the processor to receive a variable. A processor may compare a variable to one or more policies. A processor may apply one or more rules to a variable base don a comparison to one or more policies. A processor may instruct an actor to perform an action with a variable based on one or more rules. A processor may produce an output based on an action performed, wherein the output is produced using a zero-trust security principle.

### CROSS-REFERENCE TO RELATED APPLICATIONS

This application claims priority to, and the benefit of, U.S. Prov. App. No. 63/612,476, filed Dec. 20, 2023, the entirety of which is incorporated herein by reference.

### TECHNICAL FIELD

This disclosure relates to infrastructure security in network and/or application environments. In particular, this disclosure relates to a rules based policy driven engine and methods of use.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In an aspect, an apparatus is presented. An apparatus may include a processor and a memory communicatively coupled to the processor. A memory may contain instructions to cause the processor to receive a variable. A processor may compare a variable to one or more policies. A processor may apply one or more rules to a variable base don a comparison to one or more policies. A processor may instruct an actor to perform an action with a variable based on one or more rules. A processor may produce an output based on an action performed, wherein the output is produced using a zero-trust security principle.

In an aspect, a non-transitory computer readable medium containing instructions that, when executed by a processor, cause the processor to build a self protecting data object is presented. A processor may perform the steps of obtaining a digital identification of a user or computer system, obtaining a data payload, encrypting the data payload, obtaining one or more policies, and assembling the digital identification, encrypted data payload, and the one or more policies into a secure container, thereby forming a self protecting data object.

### BRIEF DESCRIPTION OF THE DRAWINGS

The foregoing aspects and many of the attendant advantages of embodiments of the present disclosure will become more readily appreciated as the same become better understood by reference to the following detailed description, when taken in conjunction with the accompanying drawings.

FIG. 1 illustrates an apparatus for a rules based policy drive engine;

FIG. 2 illustrates a rules based policy drive engine;

FIG. 3 illustrates a self protecting data object;

FIG. 4 illustrates a self protecting data object builder;

FIG. 5 illustrates a self protecting data object reader; and

FIG. 6 is an exemplary embodiment of a block diagram of a computing device that may be implemented in the apparatuses, systems, and/or methods described herein.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION OF EXEMPLARY EMBODIMENTS

Aspects of the present invention can be used to implement rules based policy driven data structures in applications, computer architecture, data objects, and/or any other data oriented technology. A rules based policy driven engine may include one or more policies and/or rules that may determine actions for an actor to take with regards to data in response to internal and/or external variables. In some embodiments, a rules based policy driven engine may allow for the creation of a self protecting data object. A self protecting data object may be data-centric, such that rather than depending on the security of networks, servers, or applications, the data itself may be intelligent, self-aware, and enabled to make decisions regarding its access based on embedded policies, rules, environmental factors, and/or other parameters. Apparatuses, systems, and methods described herein may utilize a zero-trust security principle. A “zero-trust security principle” refers to an approach to architecture, design, and implementation of software systems to never trust a user or computing device but to instead verify the user or computing device. For instance, an environment in which software may be run on may not be trusted by default, even if it is embedded in a permissioned network such as a verified corporate network.

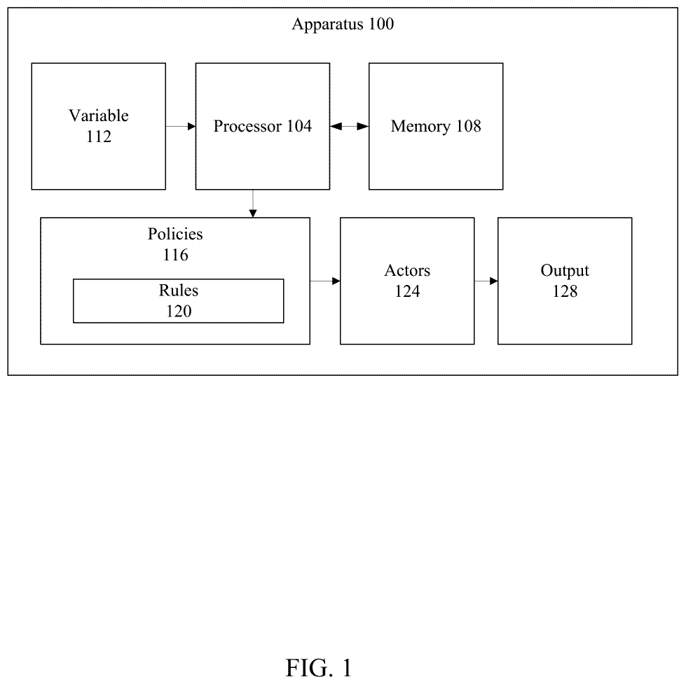

Referring now to FIG. 1, apparatus 100 for a rules based policy driven engine is illustrated. Apparatus 100 may include processor 104 and memory 108. Processor 104 may be communicatively coupled to memory 108. Memory 108 may contain instructions that may cause process 104 to perform one or more actions. Instructions of memory 108 may enable an execution of a rules based policy driven engine. Processor 104 may be configured to receive or otherwise obtain variable 112. Variable 112 may be any data input, without limitation. In some embodiments, variable 112 may be internal. For instance, an internal variable may include data that may be sourced from within apparatus 100. An internal variable may include an access count, which may be a number of times processor 104 may have been used to provide access to a protected digital resource, such as a document. Internal variables may include, but are not limited to, user identification, type of data being accessed, size of data being accessed, runtime of processor 104, last known access of a digital object, and/or other data. In some embodiments, variable 112 may be external. For instance, external variables may include, but are not limited to, dates, times, permissions set by a user or computing system, access attempts to a digital object by a user or computing system, and/or other data.

In some embodiments, processor 104 may compare variable 112 to one or more policies 116. Policies 116 may be a set of one or more rules that may be specific for an application, user, computing system, variable type, or other data. Policies 16 may be set by a user or computing system. In some embodiments, policies 116 may include a policy class. A policy class may be a set of rules specific to a certain application, user, access type, or other data. Policies 116 may be defined operational methods with zero or more attributes that may be specialized using one or more policy initialization parameters that may be drive by one or more variables 112 to execute and produce an outcome. An outcome of policies 116 may be binary, such as a 1 or 0, true of false, or other output. In some embodiments, an output of policies 116 may be non-binary. Policies 116 may include one or more rules 120. Rules 120 may be a set of defined actions to take based on one or more parameters, variables, or other factors. For instance rules 120 may dictate what action should be taken given variable 112 and policies 116. Rules 120 may determine which actor 124, if any, should perform which action. Actors 124 may be any form of software actors, without limitation. For instance, actors 124 may be logging actors, event actors, file deletion actors, and/or other actors. As a non-limiting example, a logging actor may be specialized through defining the value of its attributes by parameter definitions such as verbosity level (e.g., level of log details), log trigger events, (e.g., the events that should trigger logging), log physical location, log security (i.e., using encryption or other means to secure logs) or other parameter definitions. Actors 124 may be programmed to perform one or more actions based on at least rules 120. An action of one or more actors 124 may produce output 126. Output 128 may be any form of data output, without limitation. In some embodiments, output 128 may be a denial or approval of a user or computing system to access a data object and/or file. In some embodiments, output 128 may include a modification to one or more data files and/or objects. Output 128 may be calculated based on a zero-trust security principle.

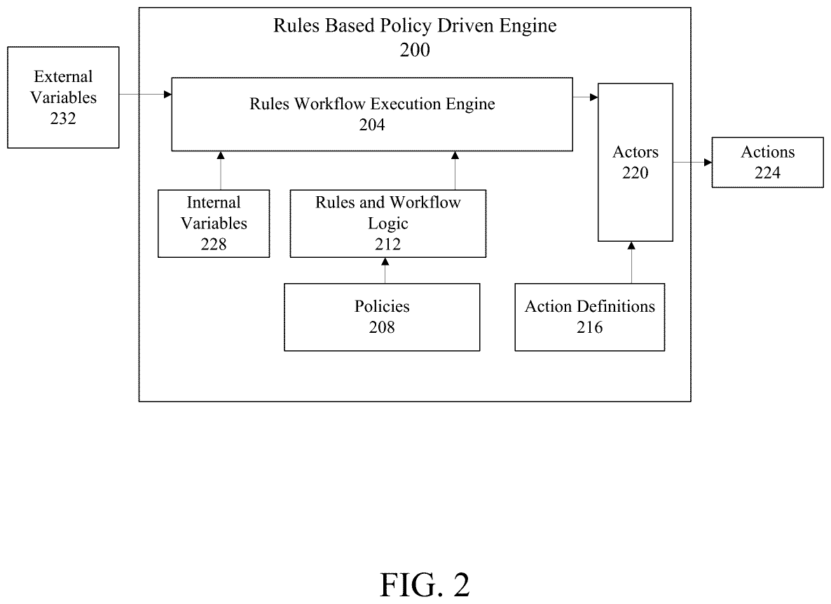

Referring now to FIG. 2, a rules based policy drive engine 200 (referred to also as “engine 200”) is illustrated. Engine 200 may include rules workflow execution engine 204 (referred to also as “execution engine 204”), internal variables 228, rules and workflow logic 212 (also referred to as “rules 212”), policies 208, action definitions 216, and/or actors 220.

Policies 208 may be the same as policies 116 as described above with reference to FIG. 1. Policies 208 may include one or more rules for a specific type of data variable, user type, computing system type, and/or other parameters. For instance, policies 208 may include one or more policies specific to one or more external variables 232, internal variable 228, and/or a combination thereof. Based on policies 208, rules 212 may be implemented. Rules 212 may dictate how external variable 232, internal variable 228, or a combination thereof should be processed, edited, or otherwise responded to. Engine 204 may input external variables 232, internal variable 228, and rules 212 (which may be derived from polices 208) and output one or more commands, such as actions 224, for actors 220 to perform. Actors 220 may be the same as actors 124 as described above with reference to FIG. 1. In some embodiments, actors 220 may perform one or more actions 224 based on action definitions 216. Action definitions 216 may detail instructions on how to perform an action for specific actors 220, external variables 232, and/or internal variables 228.

Rules 212 may include orchestrated and/or repeatable patterns of activity that may be enabled by a use of instantiated policies 208 and/or internal variable 228 and/or external variable 232 to provide outcomes in the form of actions 224. Rules 212 may take form of a directed task tree. For instance, each node in a directed task tree may receive input from one or more previous nodes and/or input from internal variables 228 and/or external variables 232. Rules 212 may be used to drive instantiated policies 208 in addition to various programmed logical constraints, conditions, and/or validation rules to produce one or more outcomes for transition to the next nodes in the directed task tree. Workflows corresponded to rules 212 may be created programmatically or through graphical workflow creation tools. Rules 212 may be transformed into a script or meta language that may be consumable by execution engine 204. Execution of rules 212 may produce an outcome as instructions for actors 220 to perform one or more actions 224. While policies 208, rules 212, actors 220, and/or actions 224 may be defined generically, application of engine 200 may be separated between applications via the logic of rules 212. Rules 212 may be plugged into different applications, which may cause various applications to act with completely new personalities and behaviors compared to their previous operations.

As a non-limiting example, engine 200 may be used in the context of an access control application that controls access to a digital resource. Policies 208 may include two policy classes, a calendar validation policy class and a network validation policy class. The calendar validation policy class may have two methods, one to check if the given date and time or within a given period and the other is a method to determine if the given date and time is a weekday. The network validation policy class has a method to verify that a given device IP is within a corporate network IP class defined by the corporate IP address range and/or its netmask. Using these two policy classes and their methods, initial parameters to the methods, and/or external variables such as device IP addresses and current times and dates, rules 212 may be defined to manage access control. For instance, rules 212 may include the following statements: Provide access to the digital resource at any time if the request is made within a prescribed calendar period. Or provide access if the request is made outside that calendar period, and the request is made from a system within the corporate network on a weekday. In all cases, only allow access if access has not been already failed 3 times.

As another non-limiting example, policies 208 may include a policy class for geo-fencing. A policy class for geo-fencing may be designed to determine if a given geo-location “P” is within a geo-fencing radius “R” given a location “L”. An instance of a policy class for geo-fencing may be initialized by setting its attributes to the value of the initialization parameters that includes the name of a city and a country for L (or alternatively the geo-coordinate for L) as well at the value for the desired geo-fencing radius attribute R, e.g., 50 miles. At the start of execution by engine 204, external variable 232 may be incorporated, which may include a latitude and/or longitude of position P. Engine 204 may output a binary value of true or false based on rules 212 derived from the policy class. For instance, engine 204 may output true if position P falls within radius R of location L, or false otherwise.

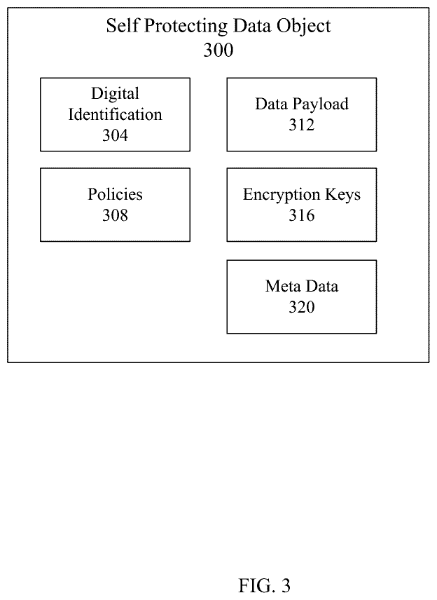

Referring now to FIG. 3, a self protecting data object 300 is presented. Self protecting data object 300 (also referred to as “data object 300”) may include digital identification 304, data payload 312, policies 308, encryption keys 316, and/or meta data 320. Data object 300 may be formed as an implementation of engine 200 as described above with reference to FIG. 2. Data object 300 may be a secure container that may include data payload 312, which may be encrypted, one or more policies 308, and/or one or more digital identifications 304.

Digital identification (ID) 304 may be a protected container that may include an identity of an individual who may be trying to become authorized to access data payload 312. Digital ID 304 may be ascertained by data object 300 by identifying one or more attributes. Attributes may include, for instance and without limitation, passwords, personal questions and challenges, access cards, access tokens, fingerprints, facial recognition, retina scans, or other attributes of a user. In some embodiments, data object 300 may ascertain digital ID 304 based on one or more attributes of a user. In other embodiments, digital ID 304 may be received via user input or from another computing device. In some embodiments, digital ID 304 may include a secure data bundle that may include personal information as well as a digital equivalent of one or more attributes. Digital ID 304 may include initialization parameters for various policies 308 of data object 300. Policies 308 may be the same as policies 208 as described above with reference to FIG. 2. Policies 308 may include one or more parameters and/or rules that may be specific to internal and/or external variables, digital ID 304, types of data of data payload 312, and/or other factors. Policies 308 may be set by a user or computing device. In some embodiments, data object 300 may determine one or more policies 308 based on data a payload 312, digital ID 304 and/or internal and/or external variables. For instance, data object 300 may be programmed to override one or more preexisting policies 308 depending on digital ID 304, data payload 312, or other data of data object 300. Policies 308 may be configured to be enabled or disabled. For instance, policies 308 may include a list of two or more policies 308, which may individually be togglable to be enabled or disabled. Data object 300 may enable or disable policies 308. In some embodiments, a user or computing system may be configured to enable or disable policies 308 if they have access to data object 300.

Digital ID 304 may include personal information, authentication policies, authorization policies, utility polices, and/or initialization parameters of any of the prior described policies. Policies of digital ID 304 may be incorporated into policies 308. Policies of digital ID 304 may be used by data object 300 to instantiate desired policy used by execution of rules and/or logic, such as described above with reference to engine 200 and execution engine 204 illustrated in FIG. 2. Digital ID 304 may be specific to a user, which may be an individual or computing device/system. In some embodiments, a user may build their digital ID 304 by providing initialization parameters for one or more policies 308 of interest in addition to their personal information.

Referring still to FIG. 3, data object 300 may include data payload 312. Data payload 312 may be any form of data, without limitation. For instance, data payload 312 may be document such as, but not limited to, word files, PowerPoints, PDF files, JPEG files, mp3 files, mp4 files, video files, and/or any other type of digitized file. Based on digital ID 304 and/or policies 308 and/or rules, data object 300 may provide authorization or denial of access to contents of data payload 312 to a user or computing device.

In some embodiments, data object 300 may include a surrogate digital ID. A surrogate digital ID may substitute in place of digital ID 304. A surrogate digital ID may not be a real digital ID 304, but may include information necessary to morph itself into a real digital ID 304 at run time. A surrogate digital ID may include a group name and/or instructions for an online service it may need to contact in order to reach a given surrogate group service to obtain an actual digital ID 304 for the user. This interaction may happen at a time when a data object reader may attempt to authenticate and authorize a user. A binding or morphing of a surrogate digital ID to an actual digital ID 304 may occur at run time or execution of instructions of data object 300.

Encryption keys 316 may include any form of encryption key, without limitation. Encryption keys 316 may be specific to data payload 312, digital ID 304, meta data 320, and/or any other data of data object 300. Encryption keys 316 may be provided to data object 300. In some embodiments, data object 300 may create encryption keys 316. Upon decryption of encryption keys 316, a user may obtain access to data payload 312 and/or other data of data object 300. Encryption keys 316 may be generated at random, and may be internal to data object 300. For instance, users or computing systems may not receive encryption keys 316.

Meta data 320 may include information about a structure and/or types of various elements of a file system, variety of index and/or structural information, and/or other data that may be useful in managing data object 300. Meta data 320 may be hidden from any individual or system that does not have access to data object 300. Meta data 320 such as a number of protected digital assets, names of protected digital assets, sizes of protected digital assets, access times of protected digital assets and/or other information may be encrypted or otherwise obscured by data object 300.

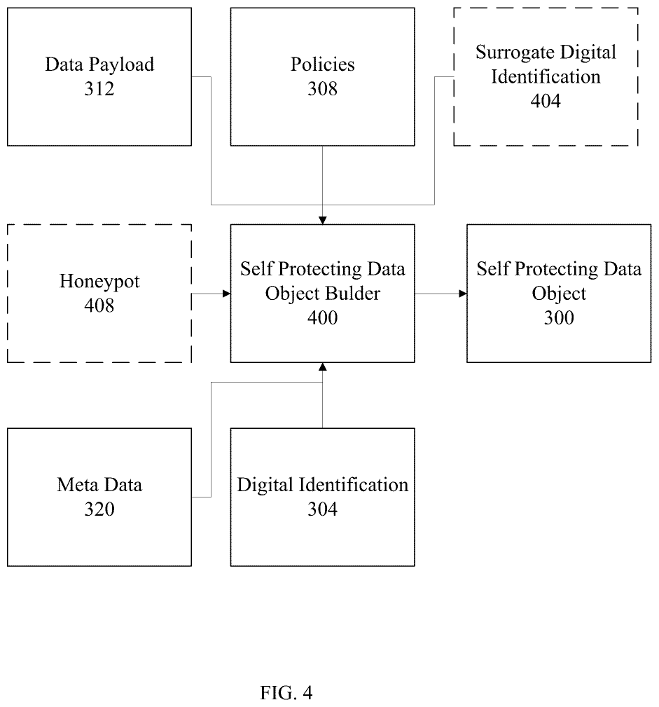

Referring now to FIG. 4, an illustration of a self protecting data object builder 400 is presented. Self protecting data object builder 400 (also referred to as “data object builder 400”) may be configured and/or programmed to generate data object 300, as described above with reference to FIG. 3. Data object builder 400 may be configured or otherwise programmed to assemble the various parts of data object 300 into data object 300. For instance, data object builder 400 may input data payload 312, policies 308, digital ID 304, and/or meta data 320 into a secure container, thereby forming data object 300. In some embodiments, at each step of an assembly of data object 300, data object builder 400 may generate one or more encryption keys that may be specific to a respective part of data object 300. For instance, data object builder 400 may encrypt data payload 312, policies 308, meta data 320, and/or digital identification 304. Encryption keys generated by object builder 400 may be assembled into data object 300. In some embodiments, surrogate digital identification 404 may be assembled into data object 300 in place of digital ID 304, such as described above with reference to FIG. 3. Data object builder 400 may assemble honeypot 408 into data object 300. Honeypot 408 may include a false replica of data payload 312. Honeypot 408 may be presented to a user who fails one or more authentication or authorization policy checks, which may give the user a false impression that they successfully accessed data payload 312.

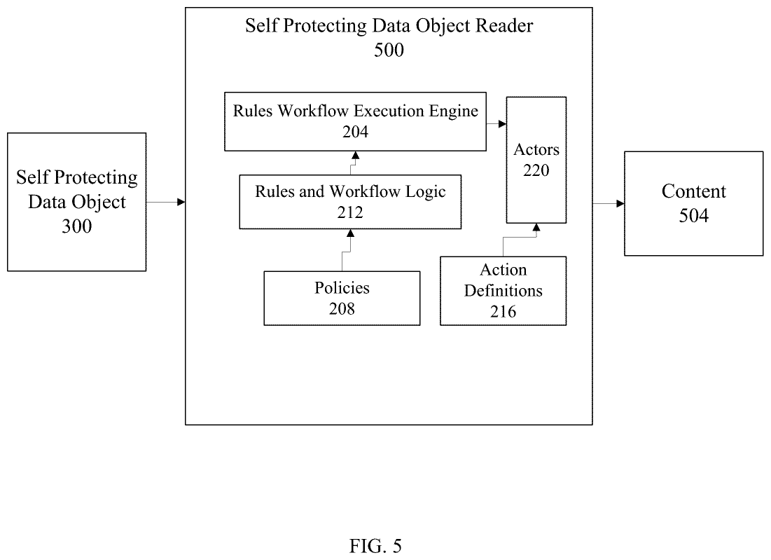

Referring now to FIG. 5, an illustration of a self protecting data object reader 500 is presented. Self protecting data object reader 500 (also referred to as “reader 500”) may include execution engine 204, rules 212, policies 208, action definitions 216, and/or actors 220, as described above with reference to FIG. 2. Reader 500 may be configured to receive data object 300 and/or external variables, such as, but not limited to, a time of day, system IP address, geolocation, or other variables. Reader 500 may utilize policies 208 and/or rules 212 to initialize execution of execution engine 204. An outcome of execution engine 204 may be one or more actions taken by one more actors 220. If policies 208 are satisfied, reader 500 may output content 504 of data object 300. Content 504 may be an entirety of data stored within data object 300. In some embodiments, content 504 may be a partial amount of data stored within data object 300. For instance, content 504 may be meta data, parts or a whole of a data payload, digital ID's, and/or other data of data object 300. A user may receive data object 300, which may in some embodiments be unreadable without reader 500. A user or computing system may need to build or obtain a digital ID in order to access data object 300 and/or reader 500.

In some embodiments, policies 208 may include authentication policies. For instance, reader 500 may request a user to authenticate themselves. Reader 500 may match user credential to credentials given by a user in an authentication process. Authentication policies may be used to authentication one or more users of data object 300. Authenticated users may be qualified to access parts or an entirety of data object 300. Authentication policies may be initialized by a user's digital ID with their existing credentials during a building process of data object 300. If existing credential match a user's digital ID, the user may be authenticated to access data object 300. In some embodiments, policies 208 may include challenged-based authentication policies. Challenged-based authentication policies may be based on what a user or computing system knows. For instance, one or more challenged-based authentication policies may be initialized by one or more challenge parameters that a user provided during construction of their digital ID. Challenge-based authentication policies may include a collection of questions or other inquiries that only a user or computing system trying to gain authentication may know. At execution time, reader 500 may present a subset of challenges to be responded to by a user or computing system claiming to be a legitimate user trying to gain access. In some embodiments, challenged-based authentication policies may include one or more parameters, such as, but not limited to, a list of challenges and their responses, acceptable variations on responses, acceptable presentation behavior, maximum wait time until a response is provided, minimum correct responses accepted, maximum incorrect responses tolerated, or other parameters. In some embodiments, biometric authentication policies may be employed, additionally or alternatively to the previously described authentication policies.

In some embodiments, authentication policies may be insignia-based. For instance, based on what a user is carrying, a user may be provided access to data object 300. User may carry an object with a digital signature, such as, but not limited to, an access card, magnetic badge, NFC chip, or other device. Insignias may be digital signatures that may be recorded at a time a digital ID may be built and may be part of a user's digital ID.

In some embodiments, policies may include one or more authorization policies. Authorization policies may be used to provide authorization an already authenticated user. In some embodiments, data object 300 may only require authorization without authentication. In some embodiments, data object 300 may require both authorization and authentication. Authorization may include a time of day authorization, day of the week authorization, geo-location authorization, calendar period authorization, device ID authorization, retention period authorization, or other authorization. In some embodiments, authorization policies may be hardware based. For instance, based upon a hardware environment in which data object 300 and/or object reader 500 is running, such as, but not limited to, platforms such as mobile, PC, laptop, tablet, smartphone, desktop, server, types of central processing units (CPU), amount of random access memory (RAM), type and speed of RAM, manufacture and model of a motherboard, type of graphics processing unit (GPU), speed of GPU, wattage provided to GPU, storage capacity, type of storage, manufacture and model of storage, and/or other parameters.

As a non-limiting example, one or more of the above attributes (e.g., Platform and CPU serial number) can be combined to define a unique hardware environment upon which reader 500 is authorized to run. In other words, one can tie the authorization to access a data object to a very specific hardware system. This is a very powerful security policy as it prevents the access to the data object from any other system or hardware platform in the world, except the very system that matches the given unique hardware initialization parameters. An example of this usage is a self protecting data application that is used in an IoT (Internet of Things) environment. In such cases, the IoT sensors will use a data object builder with a single digital ID. This digital ID is in fact the digital ID of the central system receiving the information form the sensor. The task of the sensor is simply to build the data object and send it through the network using normal means. There is no need for protecting the network (i.e., using VPN, for example) since the data is self-protecting. The data can only be accessed by the central data collecting system because the Hardware Authorization Policy within the given digital ID is tying it to the central system specifically.

In some embodiments, authorization policies may be software based. For instance, one or more software parameters such as, but not limited to, operating system type, name, build, manufacture, version, underlying hypervisor (if any), kernel parameters, file system layout and/or parameters, existence of an application, existence of a running process, and/or other parameters may be used to provide authorization to a user or computing device. As a non-limiting example, For example, the authorization to access a data object can be tied to satisfying a policy that requires the execution engine to run on an Oracle Linux OS that hosts an actively running malware detection process.

In some embodiments, authorization policies may be geo-fenced and/or network based. For instance, given a location in a form of an IP address and/or latitude and/or longitude and a given radius, a user may be authorized to access data object 300 only within a geo-fenced area. In some embodiments, a user may only be authorized to access data object 300 on a specific IP address and/or under a specific netmask. A user may be limited to becoming authorized under a specific networking system.

In some embodiments, authorization policies may be activity count based. For instance, a user may be authorized based on, but not limited to, a number of successful authorization, a number of failed authorization, a number of read accesses to a specific digital asset, a number of write accesses to a specific digital asset, or other factors. As a non-limiting example, recording company may distribute a digital recording using a player app that incorporates a rules based policy engine with a policy to only allow 3 read (play) accesses to the recording. After that the access is denied and a mitigating action could request the user to sign up and pay for the recording. Another non-limiting example would be to limit the number of failed authorization attempts, after which, a mitigating action may trigger a request to the user to furnish additional authentication factors.

In some embodiments, policies may include utility polices. Utility policies may not be directly related to authentication or authorization but may provide information of activities around data object 300, such as, but not limited to, reporting of attempts to access data object 300 and/or logging of real-time and/or time-stamped activities of reader 500. In some embodiments, utility policies may include event policies, which may be policies related to real-time events outlining various reader 500 activities. As a non-limiting example, data object 300 may contain an event policy that forces the reader 500 to “call home” for any successful or unsuccessful access attempts on the data object 300. Such calls can be displayed by a Security Information and Events Management (SIEM) system that can display a dashboard showing the status and location of all data objects 300 that have been distributed. This can provide complete end-to-end visibility to the location, time/date and/or success/failure of access attempts for all outstanding data objects 300.

Policies may include file system management utility policies, surrogate binding utility policies, and/or mitigation choice policies. File system management utility policies may include parameters that may determine whether a file system used to manage a resource within data object 300 should be read-only or read/write for all data types. A surrogate binding utility policy may be based on surrogate digital IDs instead of digital IDs, as described previously. Mitigation choice polices may determine a choice of mitigating actions that may be performed based on rules of 212 of object reader 500 and/or rules of data object 300.

With continued reference to FIG. 5, actors 225 may be programmed to perform one or more actions, such as, but not limited to, provide access, read, write, delete, report, log, send events, and/or other actions. Actions may be based on needs of an application when authentication and/or authorization policies may be satisfied and a user may be provided access. In some embodiments, actors 220 may be mitigating actors. For instance, actors 220 may be programmed to deny access, perform an escalation function, present a honey pot, shred data, self-destruct, or any other mitigating action.

It should also be noted that the present implementations can be provided as one or more computer-readable programs embodied on or in one or more articles of manufacture. The article of manufacture can be any suitable hardware apparatus. In general, the computer-readable programs can be implemented in any programming language. The software programs can be further translated into machine language or virtual machine instructions and stored in a program file in that form. The program file can then be stored on or in one or more of the articles of manufacture.

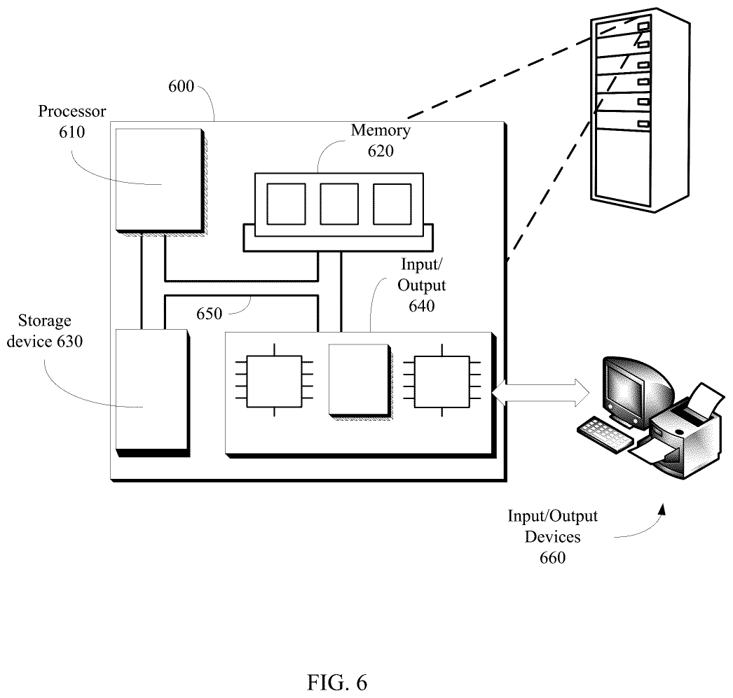

FIG. 6 is a block diagram of an example computer system 600 that may be used in implementing the technology described in this document. General-purpose computers, network appliances, mobile devices, or other electronic systems may also include at least portions of the system 600. The system 600 includes a processor 610, a memory 620, a storage device 630, and an input/output device 640. The apparatus may include disk storage and/or internal memory, each of which may be communicatively connected to each other. The apparatus 100 may include a processor 610. The processor 610 may enable both generic operating system (OS) functionality and/or application operations. In some embodiments, the processor 610 and the memory 620 may be communicatively connected. As used in this disclosure, “communicatively connected” means connected by way of a connection, attachment, or linkage between two or more elements which allows for reception and/or transmittance of information therebetween. For example, and without limitation, this connection may be wired or wireless, direct, or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. A communicative connection may be achieved, for example and without limitation, through wired or wireless electronic, digital, or analog, communication, either directly or by way of one or more intervening devices or components.

Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure. In some embodiments, the processor 610 may include any computing device as described in this disclosure, including without limitation a microcontroller, microprocessor, digital signal processor (DSP) and/or system on a chip (SoC) as described in this disclosure. The processor 610 may include, be included in, and/or communicate with a mobile device such as a mobile telephone or smartphone. The processor 610 may include a single computing device operating independently, or may include two or more computing device operating in concert, in parallel, sequentially or the like. Two or more computing devices may be included together in a single computing device or in two or more computing devices. The processor 610 may interface or communicate with one or more additional devices as described below in further detail via a network interface device. Network interface device may be utilized for connecting the processor 610 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. The processor 610 may include but is not limited to, for example, a computing device or cluster of computing devices in a first location and a second computing device or cluster of computing devices in a second location. The processor 610 may include one or more computing devices dedicated to data storage, security, distribution of traffic for load balancing, and the like. The processor 610 may distribute one or more computing tasks as described below across a plurality of computing devices of computing device, which may operate in parallel, in series, redundantly, or in any other manner used for distribution of tasks or memory between computing devices. The processor 610 may be implemented using a “shared nothing” architecture in which data is cached at the worker, in an embodiment, this may enable scalability of system 600 and/or processor 610.

With continued reference to FIG. 6, processor 610 and/or a computing device may be designed and/or configured by memory 620 to perform any method, method step, or sequence of method steps in any embodiment described in this disclosure, in any order and with any degree of repetition. For instance, the processor 610 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. The processor 610 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Each of the components 610, 620, 630, and 640 may be interconnected, for example, using a system bus 650. The processor 610 is capable of processing instructions for execution within the system 600. In some implementations, the processor 610 is a single-threaded processor. In some implementations, the processor 610 is a multi-threaded processor. In some implementations, the processor 610 is a programmable (or reprogrammable) general purpose microprocessor or microcontroller. The processor 610 is capable of processing instructions stored in the memory 620 or on the storage device 630.

The memory 620 stores information within the system 600. In some implementations, the memory 620 is a non-transitory computer-readable medium. In some implementations, the memory 620 is a volatile memory unit. In some implementations, the memory 620 is a non-volatile memory unit.

The storage device 630 is capable of providing mass storage for the system 600. In some implementations, the storage device 630 is a non-transitory computer-readable medium. In various different implementations, the storage device 630 may include, for example, a hard disk device, an optical disk device, a solid-date drive, a flash drive, or some other large capacity storage device. For example, the storage device may store long-term data (e.g., database data, file system data, etc.). The input/output device 640 provides input/output operations for the system 600. In some implementations, the input/output device 640 may include one or more network interface devices, e.g., an Ethernet card, a serial communication device, e.g., an RS-232 port, and/or a wireless interface device, e.g., an 802.11 card, a 3G wireless modem, or a 4G/5G wireless modem. In some implementations, the input/output device may include driver devices configured to receive input data and send output data to other input/output devices, e.g., keyboard, printer and display devices 660. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 630 may be implemented in a distributed way over a network, for example as a server farm or a set of widely distributed servers, or may be implemented in a single computing device.

Although an example processing system has been described in FIG. 6, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, a data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

A user may also input commands and/or other information to computer system 600 via storage device 624 (e.g., a removable disk drive, a flash drive, etc.) and/or network interface device 640. A network interface device, such as network interface device 640, may be utilized for connecting computer system 600 to one or more of a variety of networks, such as network 644, and one or more remote devices 648 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 644, may employ a wired and/or a wireless mode of communication. In general, any network topology may be used. Information (e.g., data, software 620, etc.) may be communicated to and/or from computer system 600 via network interface device 640.

Computer system 600 may further include a video display adapter 652 for communicating a displayable image to a display device, such as display device 636. Examples of a display device include, but are not limited to, a liquid crystal display (LCD), a cathode ray tube (CRT), a plasma display, a light emitting diode (LED) display, and any combinations thereof. Display adapter 652 and display device 636 may be utilized in combination with processor 604 to provide graphical representations of aspects of the present disclosure. In addition to a display device, computer system 600 may include one or more other peripheral output devices including, but not limited to, an audio speaker, a printer, and any combinations thereof. Such peripheral output devices may be connected to bus 612 via a peripheral interface 656. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. An apparatus, comprising:
a processor; and
a memory communicatively coupled to the processor, the memory containing instructions configuring the processor to:
receive a variable;
compare the variable to one or more policies;
apply one or more rules to the variable based on the comparison to the one or more policies;
instruct an actor to perform an action with the variable based on the one or more rules; and
produce an output based on the action performed, wherein the output is produced using a zero-trust security principle.

2. The apparatus of claim 1, wherein the one or more rules include an executable workflow.

3. The apparatus of claim 1, wherein the execution of the one or more rules produce one or more instructions for the actor.

4. The apparatus of claim 1, wherein the variable is an internal or external variable.

5. The apparatus of claim 1, wherein the one or more policies comprise at least a policy class.

6. The apparatus of claim 1, wherein the at least a policy class is programmed to generate a binary output.

7. The apparatus of claim 1, wherein the output includes an approval or denial of access to data.

8. A non-transitory computer readable medium containing instructions that, when executed by a processor, cause the processor to build a self protecting data object by performing the steps of:
obtaining a digital identification of a user or computer system;
obtaining a data payload;
encrypting at least the data payload;
obtaining one or more policies; and
assembling the digital identification, encrypted data payload, and the one or more policies into a secure container, thereby forming a self protecting data object.

9. The non-transitory computer readable medium of claim 8, further comprising instructions that, when executed by the processor, cause the processor to perform the step of reading the data payload of the secured container through a self protecting data object reader.

10. The non-transitory computer readable medium of claim 9, wherein the self protecting data object reader reads the data payload in response to one or both of an authentication policy and authorization policy being satisfied.

11. The non-transitory computer readable medium of claim 8, further comprising instructions that, when executed by the processor, cause the processor to perform the steps of:
obtaining one or more variables; and
comparing the one or more variables to the one or more policies of the self protecting data object to produce an output.

12. The non-transitory computer readable medium of claim 8, further comprising instructions that, when executed by the processor, cause the processor to perform the steps of:
generating metadata of the self protecting data object; and
assembling the metadata into the secure container of the self protecting data object.

13. The non-transitory computer readable medium of claim 12, wherein the general management meta data is hidden from a user or computer system that does not have access to the self protecting data object.

14. The non-transitory computer readable medium of claim 8, further comprising instructions that, when executed by the processor, cause the processor to perform the steps of:
generating a false replicate of the data payload; and
assembling the false replica into the secure container.

15. The non-transitory computer readable medium of claim 8, wherein the one or more polices comprise an authentication policy.

16. The non-transitory computer readable medium of claim 15, further comprising instructions that, when executed by the processor, cause the processor to perform the steps of:
comparing one or more variables to the authentication policy; and
either providing or denying access to a user or computing system to the self protecting data object based on the comparison.

17. The non-transitory computer readable medium of claim 8, further comprising instructions that, when executed by the processor, cause the processor to perform the steps of:
generating one or more actions for one or more actors based on the policies; and
commanding the one or more actors to perform the one or more actions.

18. The non-transitory computer readable medium of claim 17, wherein the one or more actors are mitigating actors.

19. The non-transitory computer readable medium of claim 8, wherein the one or more policies include insignia-based authorization.

20. The non-transitory computer readable medium of claim 8, wherein the one or more further comprising instructions that, when executed by the processor, cause the processor to perform the steps of generating encryption keys and assembling the encryption keys into the secure container.
